(19) United States
(12) Patent Application Publication
(10) Pub. No.: US 2022/0108469 A1
(43) Pub. Date: Apr. 7, 2022

(54) RETAIL INTELLIGENT MONITORING SYSTEM AND CAMERAS THEREOF

(71) Applicants: KEYONG LU, Diamond Bar, CA (US); YAJUN ZHANG, San Jose, CA (US); CHUN NAN KUO, New Taipei City (TW)

(72) Inventors: KEYONG LU, Diamond Bar, CA (US); YAJUN ZHANG, San Jose, CA (US); CHUN NAN KUO, New Taipei City (TW)

(21) Appl. No.: 17/478,501

(22) Filed: Sep. 17, 2021

Related U.S. Application Data
(60) Provisional application No. 63/086,338, filed on Oct. 1, 2020.
(60) Provisional application No. 63/086,347, filed on Oct. 1, 2020.

(51) Int. Cl. G06T 7/73; G06K 9/00; G06Q 10/08

(52) U.S. Cl. CPC G06T 7/73; G06K 9/00778; G06T 2207/30242; G06K 9/00255; G06T 2207/30201; G06Q 10/087

(57) ABSTRACT

A retail intelligent monitoring system including a merchandise monitoring camera coupled to a first fixture to capture first visual data of one or more articles of merchandise on a second fixture; a merchandise scanning camera coupled to a third fixture and positioned toward a fourth fixture to capture second visual data of one or more articles of merchandise on the fourth fixture; an activity tracking camera coupled to any one of the fixtures to capture third visual data of shoppers/customers' activities and configured to capture blurred visual data of shoppers such that identities of the shoppers remain unknown; and a network device. The retail intelligent monitoring system is configured to receive and analyze the first, second, and third visual data to determine information of the one or more articles of merchandise on the second and fourth fixture; and determine an inventory management procedure based on the analyzed first, second, and third visual data.

### CROSS-REFERENCE TO RELATED APPLICATIONS

The present application claims priority benefit of U.S. Provisional Application No. 63/086,338, filed on Oct. 1, 2020, and U.S. Provisional Application No. 63/086,347, filed on Oct. 1, 2020, which is hereby incorporated by reference in its entirety.

### FIELD

The present disclosure generally relates to an intelligent monitoring system including a plurality of cameras for monitoring inventories and shopper activities, specifically in a retail environment. In particular, the present disclosure seeks to improve retail management and customer experience with the intelligent monitoring system and the cameras thereof.

### BACKGROUND

Inventory management in a retail environment has been a labor intensive experience for many and for a long time. Such experience is mostly contributed to a lack of updated visibility and clarity on the inventory available to in-store shoppers (e.g., in-store shopper may find desired merchandise on a store website but not physically available to the in-store shopper because the merchandise is in a back stockroom, on an overhead shelf, in a return section, being misplaced by another customer or store associate, high frequency customer returns with free returns as part of a business model, inaccurate forecasts of products from different vendors), or inefficient processes (e.g., inexperience staffing, innate human error, or insufficient procedures for monitoring and stocking each article of merchandise on the shelves). The above contributions may be magnified multiple folds when comparing a local brick and mortar store to a warehouse-type wholesale store. The bottom line is that the traditional inventory management system overall may be an inefficient process. However, as digital cameras lower in cost per unit while being smaller in size, digital cameras are becoming more prevalently applied in many different industries, such as home security, close-proximity monitoring (e.g. body camera), etc. The potential market of utilizing cameras for inventory management in a retail environment may be enormous, and may provide a more efficient way to manage inventory and differentiate the store experience for the customers/shoppers, store management, and retail staff.

### SUMMARY

The present disclosure generally relates to an intelligent monitoring system including a plurality of cameras for monitoring inventories and shopper activities.

In accordance with one aspect of the present disclosure, a retail intelligent monitoring system may include a merchandise monitoring camera coupled to a surface of a first fixture, a merchandise scanning camera, a activity tracking camera, and a network device. The merchandise monitoring camera may be configured to capture first visual data of one or more articles of merchandise on a second fixture near the first fixture. The merchandise scanning camera may be coupled to a third fixture. The merchandise scanning camera may be positioned toward the fourth fixture and configured to capture second visual data of the one or more articles of merchandise on the fourth fixture. The activity tracking camera may be coupled to any one of the first fixture, the second fixture, the third fixture, and the fourth fixture and configured to capture third visual data of activities within a predefined field of view of the activity tracking camera. The activity tracking camera may be configured to capture blurred visual data of shoppers such that identities of the shoppers remain unknown. The network device may include a communication module communicatively coupled to the merchandise monitoring camera, the merchandise scanning camera, and the activity tracking camera, a processor communicatively coupled to the communication module, and a non-transitory machine-readable memory. The non-transitory machine-readable memory storing instructions that, when executed by the processor, cause the retail intelligent monitoring system to receive the first, second, and third visual data, analyze the first, second, and third visual data associated with the one or more articles of merchandise on the second fixture and the fourth fixture to determine at least one of inventory information of the one or more articles of merchandise on the second fixture and the fourth fixture and tidiness information of the one or more articles of merchandise on the second fixture and the fourth fixture, and determine an inventory management procedure based on analyzing the first, second, and third visual data from the merchandise monitoring camera, the merchandise scanning camera, and the activity tracking camera.

In some implementations, the merchandise monitoring camera may be configured to capture images of the one or more articles of merchandise on the second fixture at pre-determined time intervals.

In some implementations, the merchandise scanning camera may be configured to capture images of the one or more articles of merchandise on the second fixture at pre-determined time intervals.

In some implementations, the merchandise scanning camera may include an adjustable shutter frame.

In some implementations, the merchandise scanning camera may be coupled to the third fixture facing the fourth fixture on an opposite side of an aisle.

In some implementations, the non-transitory machine-readable memory may store additional instructions that, when executed by the processor, cause the intelligent monitoring system to analyze the second visual data from the merchandise scanning camera to identify a shelf display error, and provide an alert based on the identified shelf display error.

In some implementations, the non-transitory machine-readable memory may store additional instructions that, when executed by the processor, cause the intelligent monitoring system to analyze the third visual data from the activity tracking camera to determine at least one of a number of shoppers visit the second fixture within a predetermined time period, an amount of time each of the shoppers spends in front of the second fixture, which of the one of the one or more articles of merchandise on the second fixture are shown to be of interest by each of the shoppers, and an estimated group or category of each of the shoppers.

In some implementations, the non-transitory machine-readable memory may store additional instructions that, when executed by the processor, cause the intelligent monitoring system to analyze the third visual data from the activity tracking camera to track a shopper's facial movements to determine which of the one or more articles of merchandise on the second fixture are being looked at.

In some implementations, the inventory management procedure may include at least one of generating an inventory report based on the inventory information, generating a tidiness report based on the tidiness information, generating a shopper's interest report based on the shopper's activities, generating a merchandise conversion report based on the shopper's interest and final sales transaction, generating a customer behavioral report based on the shopper's interest and completion of the final sales transaction, coupling to a retail intelligent display system to execute marketing or sales related campaign based on the shopper's interests and behaviors, and coupling to a loss prevention system to deter theft-related activity.

In some implementations, the inventory management procedure may include at least one of generate an inventory alert based on the inventory information and generate a tidiness alert based on the tidiness information.

In some implementations, the network device may be coupled to a backend device.

In accordance with another aspect of the present disclosure, a method for a retail intelligent monitoring system may include a merchandise monitoring camera, a merchandise scanning camera, an activity tracking camera, and a network device. The method may include receiving first visual data captured by the merchandise monitoring camera coupled to a first fixture, the merchandise monitoring camera configured to capture the first visual data of one or more articles of merchandise on a second fixture near the first fixture, receiving second visual data captured by the merchandise scanning camera coupled to a third fixture, the merchandise scanning camera configured to capture second visual data of the one or more articles of merchandise on a fourth fixture, receiving third visual data captured by the activity tracking camera coupled to any of the first fixture, the second fixture, the third fixture, and the fourth fixture, the activity tracking camera configured to capture third visual data of activities within a predefined field of view of the activity tracking camera, the activity tracking camera configured to capture blurred visual data of shoppers such that identities of the shoppers remain unknown, analyzing the first, second, and third visual data associated with the one or more articles of merchandise on the second fixture and the fourth fixture to determine at least one of inventory information of the one or more articles of merchandise on the second fixture and the fourth fixture and tidiness information of the one or more articles of merchandise on the second fixture and the fourth fixture, and determining an inventory management procedure based on analyzing the first, second, and third visual data from the merchandise monitoring camera, the merchandise scanning camera, and the activity tracking camera.

In some implementations, the merchandise monitoring camera may be configured to capture images of the one or more articles of merchandise on the second fixture at pre-determined time intervals.

In some implementations, the merchandise scanning camera may be configured to capture images of the one or more articles of merchandise on the fourth fixture at pre-determined time intervals.

In some implementations, the merchandise scanning camera may include an adjustable shutter frame.

In some implementations, the merchandise scanning camera may be coupled to the third fixture facing the fourth fixture on an opposite side of an aisle.

In some implementations, the method may further include analyzing the second visual data from the merchandise scanning camera to identify a shelf display error, and providing an alert based on the identified shelf display error.

In some implementations, the method may further include analyzing the third visual data from the activity tracking camera to determine at least one of a number of shoppers visit the second fixture within a predetermined time period, an amount of time each of the shoppers spends in front of the second fixture, which of the one of the one or more articles of merchandise on the second fixture are shown to be of interest by each of the shoppers, and an estimated group or category of each of the shoppers.

In some implementations, the method may further include analyzing the third visual data from the activity tracking camera to track a shopper's facial movements to determine which of the one or more articles of merchandise on the second fixture are being looked at.

In some implementations, the method may further include generating an inventory report based on the inventory information, generating a tidiness report based on the tidiness information, generating a shopper's interest report based on the shopper's activities, generating a merchandise conversion report based on the shopper's interest and final sales transaction, generating a customer behavioral report based on the shopper's interest and completion of the final sales transaction, coupling to a retail intelligent display system to execute marketing or sales related campaign based on the shopper's interests and behaviors, and coupling to a loss prevention system to deter theft-related activity.

### BRIEF DESCRIPTION OF DRAWINGS

Aspects of the present disclosure are best understood from the following detailed description when read with the accompanying figures. Various features are not drawn to scale. Dimensions of various features may be arbitrarily increased or reduced for clarity of discussion.

FIG. 1 is a schematic diagram of an example retail intelligent monitoring system in accordance with an implementation of the present disclosure.

FIG. 2 is a schematic diagram of a plurality of cameras of an example retail intelligent monitoring system in accordance with an implementation of the present disclosure.

FIG. 3 is a schematic diagram of a plurality of cameras of an example retail intelligent monitoring system in accordance with an implementation of the present disclosure.

FIG. 4 is a schematic diagram of a plurality of cameras of an example retail intelligent monitoring system in accordance with an implementation of the present disclosure.

FIG. 5 is a schematic diagram illustrating example shutter frames of a camera of the retail intelligent monitoring system in accordance with an example implementation of the present disclosure.

FIG. 6 is a schematic diagram of a plurality of cameras of an example retail intelligent monitoring system in a retail environment in accordance with an implementation of the present disclosure.

FIG. 7 is a schematic diagram illustrating example visual data processing with example filters applicable to a camera in accordance with an example implementation of the present disclosure.

FIG. 8 is a flowchart diagram illustrating an example method performed by a retail intelligent monitoring system in accordance with example implementations of the present disclosure.

FIG. 9 is a flowchart diagram further illustrating an example implementation of the method of the retail intelligent monitoring system in FIG. 8.

FIG. 10 is a flowchart diagram further illustrating another example implementation of the method of the retail intelligent monitoring system in FIG. 8.

FIG. 11 is a flowchart diagram further illustrating another example implementation of the method of the retail intelligent monitoring system in FIG. 8.

FIG. 12 is a flowchart diagram further illustrating another example implementation of the method of the retail intelligent monitoring system in FIG. 8.

FIG. 13 is a schematic diagram illustrating a plurality of camera modules of an example retail intelligent monitoring system in a retail environment in accordance with an implementation of the present disclosure.

FIG. 14 is a schematic diagram illustrating a camera module of an example retail intelligent monitoring system in accordance with an implementation of the present disclosure.

### DESCRIPTION

The following disclosure contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art.

Unless noted otherwise, like or corresponding elements among the figures may be indicated by like or corresponding reference numerals. Moreover, the drawings and illustrations in the present disclosure are generally not to scale, and are not intended to correspond to actual relative dimensions.

For the purposes of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “in one implementation,” or “in some implementations,” which may each refer to one or more of the same or different implementations. The term “comprising” means “including, but not necessarily limited to” and specifically indicates open-ended inclusion or membership in the so-described combination, group, series, and the equivalent. The expression “at least one of A, B and C” or “at least one of the following: A, B and C” means “only A, or only B, or only C, or any combination of A, B and C.”

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

In one or more implementations of the present disclosure, the retail intelligent monitoring system aims to leverage the advantages of digital cameras, for example, small in size and lower in cost than a traditional camera, to improve the overall efficiency and accuracy of inventory management by providing full and dynamic coverage of all articles of merchandise on all store fixtures (e.g., racks, shelves, decks, levels, hooks, wire baskets, display case, tables, hangers, panels, etc.) in at least one store. The cameras of the retail intelligent monitoring system in the present disclosure include at least one merchandise monitoring camera and at least one merchandise scanning camera configured to capture visual data (e.g. images, still images, videos, etc.) of the articles of merchandise on each store fixture. A processor (e.g., a central processing unit in a terminal device, a local server, a backend server, etc.) of the retail intelligent monitoring system may communicatively connect to the cameras of the present disclosure, process or analyze the captured visual data, and to identify inventory or other information relating to inventory management, for example, information indicating inventory of the articles of merchandise is present but the articles are not physically arranged according to a predetermined display position. The captured visual data may be analyzed to identify each article of merchandise, identify the position of each article of merchandise with respect to the positions of all other articles of merchandise within a predetermined section in the store, identify the quantity of articles of merchandise within each predetermined section in the store, such that the inventory management (e.g., merchandiser in headquarter, etc.) may have an updated and accurate access to the visual data and status of each article of merchandise in a store. For example, a store inventory manager may instantly determine whether certain articles or merchandise are low in stock, fully stocked, arranged in place, or fell off a store fixture such that the manager may quickly determine whether to replenish a merchandise even before transaction of the merchandise is completed, perform no action to properly arranged articles of merchandise, or replace a damaged merchandise that fell off a store fixture, but are not limited to the example provided herein.

In one or more implementations of the present disclosure, the cameras of the retail intelligent monitoring system may also include an activity tracking camera that tracks shopper/customer activities and generate reports on shopper/customer activities in connection with the merchandise on store fixtures. For example, the activity tracking camera may track the quantity of shoppers and customers that have visited a certain shelf section in a store where an certain merchandise is placed, an average time that each shopper and customer stayed in a specific shelf section in a store where another merchandise is placed, and the specific merchandise that the shopper and customer has eyeballed, touched, moved or picked. The activity tracking camera with the merchandise monitoring cameras and the merchandise scanning cameras of the retail intelligent monitoring system may also facilitate the determination of a possible group/category (e.g., age, sex, an individual or a family, etc.) that the shopper and customer belongs to, based on the analysis of the visual data captured by the cameras of the retail intelligent monitoring system. The visual data captured by the cameras of the retail intelligent monitoring system and the report generated by the retail intelligent monitoring system may provide store and inventory management a tool to better understand their shopper/customer behaviors, and gain advantages over their competitors. The retail intelligent monitoring system of the present disclosure may determine, for example, a total of 100 shopper visits from the computer mouse section of a store during business hours in a range of 5 days, an average time that a shopper spent in front of the computer mouse section may be 2 minutes, and 50 of the 100 visits are for a specific brand of computer mouse. The retail intelligent monitoring system may further determine that of those 50 visits for the specific brand of computer mouse, none of the visits completed in a transaction. With such data generated in a report, a merchandiser, for example, may focus more on the reasons for such a low visit-to-transaction ratio (e.g., a ratio of visit frequency to transaction frequency, 0:50), competitive pricing, favoritism of a stock merchandise versus a displayed merchandise, or reasons of non-purchase (e.g., missing merchandise, expired/outdated items, low quality items, high priced items, etc.) instead of focusing majority of the store resources on inventory management alone. Since the cameras in the retail intelligent monitoring system of the present disclosure require capturing details of each article of merchandise, the cameras are preferably high resolution cameras, such as High definition (HD) cameras, Full High Definition (FHD) cameras, Ultra High Definition (UHD) cameras, 4K cameras, or any camera having higher resolution.

In one or more implementations of the present disclosure, the activity tracking camera in the retail intelligent monitoring system may protect privacy of all shoppers (e.g., potential customers) and customers (e.g., patrons) by protecting the shoppers' and customers' identities (e.g., faces) while the merchandise monitoring camera and the merchandise scanning camera may provide full coverage monitoring of all the articles of merchandise on or off the store fixtures dynamically.

In one or more implementations of the present disclosure, the cameras of the retail intelligent monitoring system may act as security cameras to protect the store from loss prevention, theft, etc.

In one or more implementations of the present disclosure, the cameras of the retail intelligent monitoring system may track repeated customers in order to provide promotions more personal to the repeated customers or track frequent shoppers in order to provide promotions more personal to the frequent shoppers.

In one or more implementations of the present disclosure, the cameras of the retail intelligent monitoring system may facilitate generation of reports to improve inventory management and optimize human resources to better manage store traffic.

In one or more implementations of the present disclosure, the merchandise monitoring camera and the activity tracking camera may be integrated in a single electronic device in which the activity tracking camera may include a field of view facing away (e.g., front-facing) from a store fixture while the merchandise monitoring camera may include field of views facing toward (e.g., back-facing) the store fixture. In some implementations, the merchandise monitoring camera and the activity tracking camera may be separate electronic devices. In some implementations, the merchandise monitoring camera, the merchandise scanning camera, and the activity tracking camera may be separate electronic devices or integrated into a single electronic device. In some implementations, the merchandise monitoring camera, the merchandise scanning camera, and the activity tracking camera may be integrated into a store fixture as a single electronic device, but the configurations of the cameras and fixture are not limited to the example configurations provided herein.

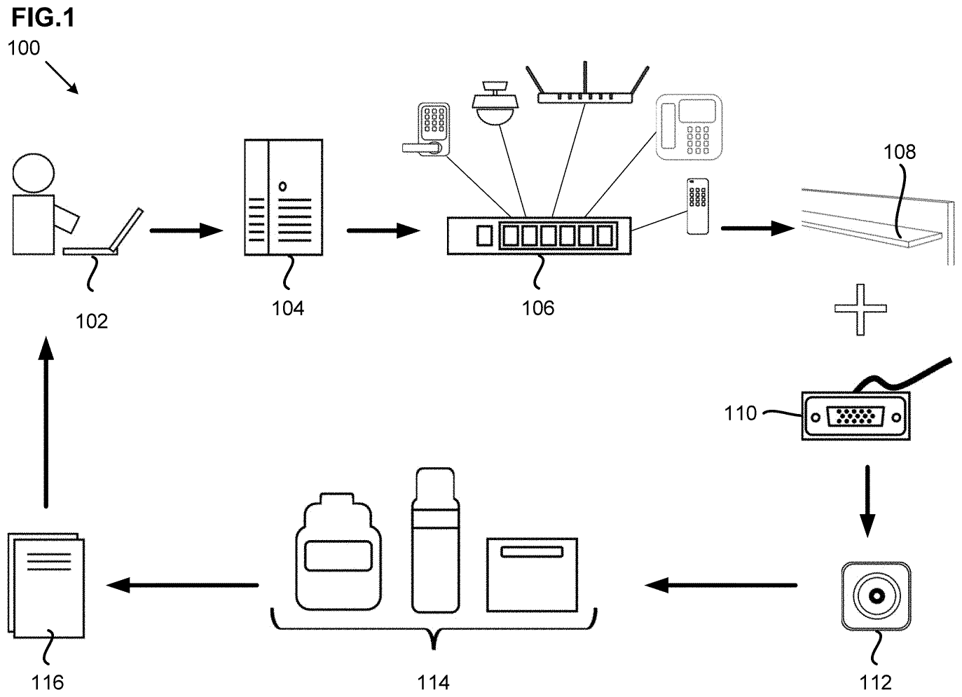

FIG. 1 is a schematic diagram of an example retail intelligent monitoring system 100 in accordance with an implementation of the present disclosure. In FIG. 1, the example retail intelligent monitoring system 100 may include a terminal device 102, a network device 104, a routing device (e.g., including an ethernet connection slot) 106, at least one store fixture 108, at least one camera 112 coupled to the at least one store fixture 108, a data and/or power connector (e.g., base connector) 110 coupled to the at least one store fixture 108 and the at least one camera 112 to provide power and means for data communication between the camera 112, the network device 104, and the terminal device 102, such that visual data (e.g., still images, videos, etc.) of at least one article of merchandise (e.g., product, etc.) 114 on the at least one store fixture 108 may be monitored, and at least one report (e.g., an inventory report, a tidiness report, etc.) 116 may be provided to the terminal device 102. In one or more implementations, the data and/or power connector 110 of the example retail intelligent monitoring system 100 may include power over ethernet (POE) as the main power supply system. The POE may provide a maximum power of 100 W. The POE may utilize a mature and widely used standard/protocol or a newly developed POE standard/protocol.

In one or more implementations of the present disclosure, the example retail intelligent monitoring system 100 in FIG. 1 may include the terminal device 102, for example operated by an operator (store manager, a corporate user, etc.), that communicates with the network device 104 and the routing device 106 via one or more networks (e.g., a local network, a public network, such as the internet, etc.), and further communicates and controls the at least one camera 112 via the data and/or power connector 110 such that the at least one camera may capture visual data (e.g., image data, video data, etc.) associated with the merchandise 114 on the at least one store fixture 108 and visual data of at least one of customer activities (e.g., patrons) and shopper activities (e.g., potential patrons) in connection with the merchandise 114. The terminal device 102 may include, for example, a computer, a laptop, or a tablet, each having a processor (e.g., CPU, etc.) and a non-transitory machine-readable memory, for processing the visual data captured by the camera 112, but are not limited to the examples provided herein. The network device 104 may be, for example, a local/remote server, or a backend device, each having a processor (e.g. CPU, etc.) and a non-transitory machine-readable memory, for processing the visual data captured by the camera 112, but are not limited to the examples provided herein. The network device 104 may include a communication module (not shown, e.g., transceiver, etc.) that is communicatively coupled between the terminal device 102, the network device 104, and the at least one camera 112 such that the captured visual data, images or videos of the merchandise 114 on the store fixture 108 or images or videos of the shopper/customer activities in connection with the merchandise 114, may be communicated between the terminal device 102, the network device 104, and the at least one camera 112 for analysis and report generation. In one or more implementations, the network device 104 of the example retail intelligent monitoring system 100 may use POE as the communication channel and share the same line as the power supply. In another implementation, the network device 104 may not use Wi-Fi or Bluetooth Low Energy (BLE). In one or more implementations, the network device 104 of the example retail intelligent monitoring system 100 may include wireless (e.g., Wireless Fidelity WI-FI, hotspot, etc.) and/or wired (e.g., POE, routers, hubs, splitters, etc.) components for data communication between the terminal device 102 and the at least one camera 112 of the example retail intelligent monitoring system 100.

In one or more implementations of the present disclosure, the retail intelligent monitoring system 100 may receive the visual data captured by the at least one camera 112, analyze the captured visual data, and generate data regarding the merchandise 114 on the store fixture 108 or the shopper/customer activities in connection with the merchandise 114 via the processor in the terminal device 102 or the network device 104. The captured visual data may indicate information regarding the merchandise 114 on the store fixture 108 ranging from the absence of a single article of merchandise 114 on the store fixture 108 (e.g., no inventory) to multiple articles of merchandise 114 on the store fixture 108 (e.g., full inventory), or may indicate a price tag for the merchandise 114 is missing entirely. The visual data may also indicate information regarding the relative positions of the one or more articles of merchandise 114 on the store fixture 108. The retail intelligent monitoring system 100 may analyze the captured visual data associated with shopper/customer activities in connection with the merchandise 114 while protecting their privacies to determine at least one of inventory information and tidiness information regarding the article of merchandise 114 on the store fixture 108, and determine at least one inventory management procedure 116 based on the analysis of the captured visual data from the at least one camera 112. In some implementations, the inventory management procedure 116 may include at least one of generating an inventory report based on the determined inventory information, generating an inventory alert based on the determined inventory information, generating a tidiness report based on the determined tidiness information, and generating a tidiness alert based on the determined tidiness information such that store management in a retail environment may be improved with the retail intelligent monitoring system 100. As discussed above, the retail intelligent monitoring system 100 may analyze the captured visual data with the processor in at least one of the terminal device 102 and the network device 104 to identity at least one article of merchandise 114, for example, by comparing a stock image of the at least one article of merchandise 114 with a certain algorithm and identify a quantity of the at least one article of merchandise 114. The inventory report may include information regarding all articles of merchandise in a store, such as a comprehensive list of showing quantity of the articles of merchandise (e.g., from no inventory to full inventory), a status of the articles of merchandise (e.g., sold, in process of stocking, or any status relating to the articles of merchandise that may require attention from inventory management, etc.), or other properties associated with the articles of merchandise. The tidiness report may include a description or a summary regarding a tidiness status of the articles of merchandise on store fixtures, for example, relative positions of one or more articles of merchandise on a store fixture, a particular article of merchandise may be on a store fixture not designated for the particular article of merchandise, or articles of merchandise on a predetermined store fixture may be arranged in a configuration different from the predetermined design, etc.). As such, inventory management in a retail environment may be improved with the retail intelligent monitoring system 100.

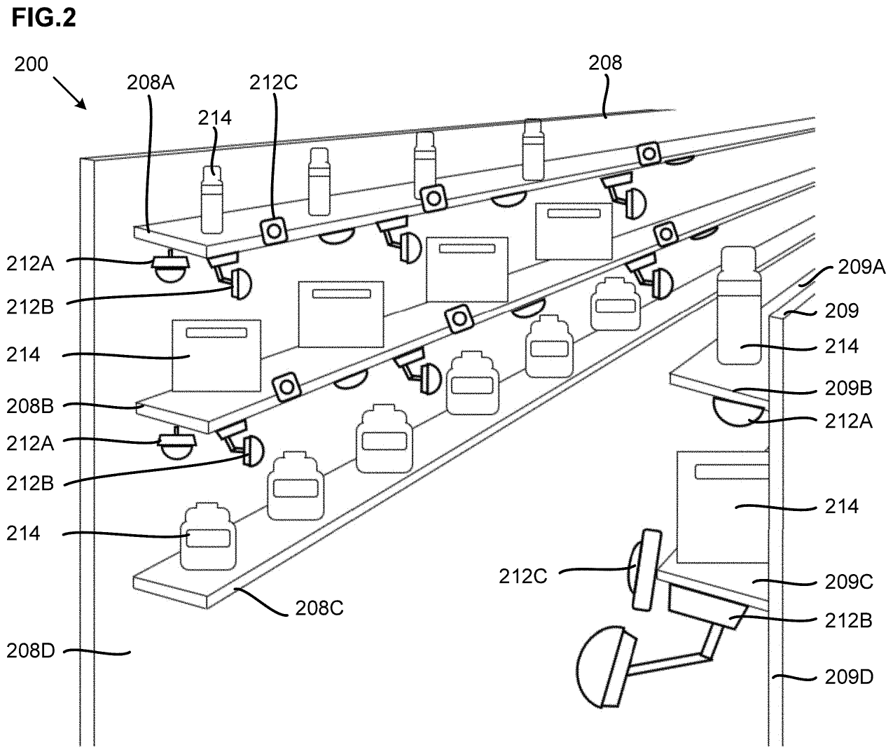

FIG. 2 is a schematic diagram of a plurality of cameras of an example retail intelligent monitoring system in accordance with an implementation of the present disclosure. In one or more implementations of the present disclosure, the example retail intelligent monitoring system 200 may include a merchandise monitoring camera, a merchandise scanning camera, and an activity tracking camera coupled to a plurality of store fixtures (e.g., racks, shelves, decks, levels, hooks, wire baskets, display case, tables, hangers, panels, etc.). In one or more implementations of the present disclosure, the example retail intelligent monitoring system 200 may include a plurality of cameras having at least one merchandise monitoring camera 212A, at least one merchandise scanning camera 212B, and at least one activity tracking camera 212C coupled to a plurality of store fixtures which may include two racks 208, 209 and a plurality of shelves and panels (e.g., 208A, 208B, 208C, 208D, 209A, 209B, 209C, 209D etc.) coupled to the racks 208, 209.

In one or more implementation, the at least one merchandise monitoring camera 212A may be coupled to a surface of a first shelf 208A of a first rack 208 (a first store fixture) to capture first visual data (e.g., image or video data) of one or more articles of merchandise 214 on a second shelf 208B near the first shelf 208A (a second store fixture near the first store fixture) such that inventory and tidiness information regarding the articles of merchandise 214 on the second shelf 208B (the second store fixture) may be captured with the best visibility and coverage. In some implementations, the merchandise monitoring camera 212A may be coupled to a bottom surface of the first shelf 208A to capture first visual data of the merchandise 214 on the second shelf 208B. In some implementations not explicitly shown, the merchandise monitoring camera 212A may be coupled to a side surface of the first shelf 208A to capture first visual data of the merchandise 214 on another shelf of another rack located left or right of the first shelf 208A of the first rack 308. In one or more implementations, the merchandise monitoring camera 212A, the merchandise scanning camera 212B, and the activity tracking camera 212C may be any type of digital camera, such as a small sized pinhole camera hidden away from shoppers' or customers' normal view for aesthetics, a regular sized webcam, a compact camera, a bridge camera, a mirrorless camera, and a combination of the cameras describe above. In one or more implementations, the merchandise monitoring camera 212A on one store fixture may be configured to capture the first visual data of the merchandise 214 on another store fixture at pre-determined time intervals. The pre-determined time intervals may be, for example, still image data captured periodically (e.g., every 5 to 10 seconds), but are not limited to the examples provided herein. In some implementations, the first visual data of the merchandise 214 on a store fixture (e.g., 208B) captured by the merchandise monitoring camera 212A may be a most recent photo of the merchandise 214. A processor (not shown) of at least one of the terminal device 102 and the network device 104 shown in FIG. 1 may analyze the first visual data (e.g., the most recently captured photo) of the merchandise 214 and determine an inventory procedure of generating an inventory report (e.g., an alert message with the most recently captured photo of the merchandise 214), such that a user of the terminal device 102 or the network device 104 may review the inventory report and determine whether actions or further review on the merchandise 214 are necessary.

In one or more implementations, the at least one merchandise scanning camera 212B may be coupled to a front panel 209C (a third store fixture) of the second rack 209 and may be positioned toward an entire first rack 208 (e.g., fourth fixture) to capture second visual data of the merchandise 214 on the first rack 208 such that inventory and tidiness information regarding the articles of merchandise 214 on all shelves of the first rack 208 may be captured. In some implementations, the merchandise scanning camera 212B may be coupled to a front panel 209C of the second rack 209 to position a predefined field of view of the merchandise scanning camera 212B towards the general direction of or at a predefined angle with respect to the first rack 208 such that the second visual data of any merchandise 214 on any shelf (e.g., 208A, 208B, etc.) of the first rack 208 may be captured. In some implementations, the merchandise scanning camera 212B may be coupled to the second rack 209 to capture the second visual data of the merchandise 214 on the first rack 208 that is on a side of an aisle opposite to the second rack 209 as shown in FIG. 2. In one or more implementations, the merchandise scanning camera 212B on one store fixture may be configured to capture the second visual data of the merchandise 214 on another store fixture at pre-determined time intervals. The pre-determined time intervals may be, for example, still image data captured periodically (e.g., every 5 to 10 seconds), but are not limited to the examples provided herein. In some implementations, the second visual data captured by the merchandise scanning camera 212B may be analyzed by a processor (not shown) of at least one of the terminal device 102 or the network device 104 shown in FIG. 1 to identify a shelf display error and provide an alert based on the identified shelf display error. The shelf display error, for example, may be a price tag missing or inaccurate pricing on a price tag, but are not limited to the examples provided herein.

In one or more implementations, the at least activity tracking camera 212C may be coupled to any store fixtures (e.g., racks 208, 209; shelves 208A, 208B, 209A, 209B; front panels 208C, 209C; back panels 208D, 209D, etc.) to capture third visual data regarding the shopper/customer activities in connection with the merchandise 214 within a predefined field of view of the activity tracking camera 212C while protecting their privacies. In some implementations, the activity tracking camera 212C may automatically blur the customers'/shoppers' identities (e.g., faces, etc.) and capture the third visual data of the shopper/customer activities in connection with the merchandise 214 within the predefined field of view of the activity tracking camera 212C such that the customers'/shoppers' privacies are protected. In some implementations, the activity tracking camera 212 may be configured to capture blurred visual data via a blurry lens capturing visual data or a software blurring the captured visual data to protect customers'/shoppers' privacies, such as identities. The examples of capturing blurry visual data of shopper/customer activities are not limited to the examples provided herein. The first, second, and third visual data respectively captured by the merchandise monitoring camera 212A, the merchandise scanning camera 212B, and the activity tracking camera 212C may be output, for example, to any one of the terminal device 102 and the network device 104 of the retail intelligent monitoring system 100 in FIG. 1 for analysis. In some implementations, the third visual data captured by the merchandise scanning camera 212C may be analyzed by a processor (not shown) of at least one of the terminal device 102 or the network device 104 in example system 100 of FIG. 1 to determine at least one of a total number of shoppers who visited a specific store fixture for a specific merchandise within a predetermined time period, an amount of time that each shopper spends in front of a specific store fixture for a specific merchandise, which specific article of merchandise among articles of merchandise on the plurality of store fixtures is shown to be of interest by each shopper, and an estimated group or category (e.g., age, gender, etc.) of each shopper. In some implementations, the third visual data captured by the merchandise scanning camera 212C may be analyzed by the processor (not shown) of at least one of the terminal device 102 or the network device 104 in example system 100 of FIG. 1 to track a shopper's facial (e.g., eye) movements and determine which article of merchandise among articles of merchandise on a plurality of fixtures are being looked at.

In one or more implementations, the merchandise monitoring camera 212A, the merchandise scanning camera 212B, and the activity tracking camera 212C of the example retail intelligent monitoring system 200 may be easily attached to and removed from any of the store fixtures, readily replaceable and upgradable to lower power consumption and costs, and provided with low light visibility capability and scratch resistance lens. In one or more implementations, the merchandise monitoring camera 212A, the merchandise scanning camera 212B, and the activity tracking camera 212C may each be coupled with a light source (e.g., a light emitting diode (LED) light source) where the merchandise 114 is located on fixtures or in areas with low light visibility.

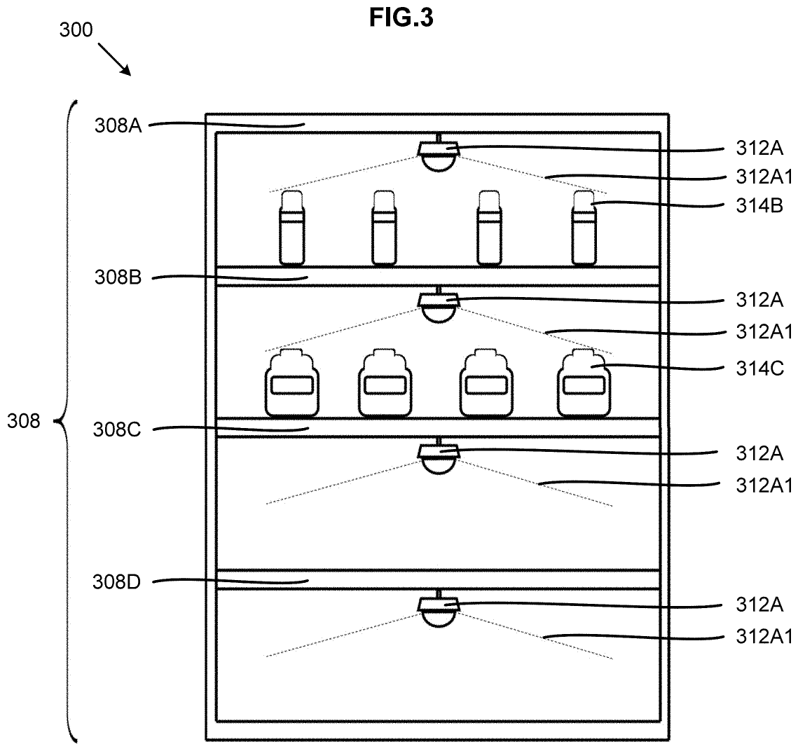

FIG. 3 is a schematic diagram of a plurality of cameras of an example retail intelligent monitoring system in accordance with an implementation of the present disclosure. In one or more implementations, the example retail intelligent monitoring system 300 may include a plurality of merchandise monitoring cameras, each coupled to a surface of a first store fixture, to capture first visual data of articles of merchandise on a second store fixture near the first store fixture such that inventory and tidiness information regarding the articles of merchandise on the second store fixture may be captured. In some implementations, four merchandise monitoring cameras 312A are respectively coupled to bottom surfaces of the four shelves 308A, 308B, 308C, 308D. The merchandise 314B, 314C may be respectively positioned on a second shelf 308B and a third shelf 308C. Each merchandise monitoring camera 312A has a predefined field of view 312A1 that may be predetermined in a position above at least one article of merchandise to capture visual data of the at least one article of merchandise below each merchandise monitoring camera 312A. For example, in FIG. 2, the merchandise 314B on the second shelf 308B are within the field of view 312A1 of the merchandise monitoring camera 312A above the merchandise 314B on the second shelf 308B, visual data of the merchandise 314B on the second shelf 308B may be captured by the merchandise monitoring camera 312A above the merchandise 314B. Similarly, visual data of the merchandise 314C on the third shelf 308C may be captured by the merchandise monitoring camera 312A above the merchandise 314C. In some implementations not explicitly shown, the merchandise monitoring camera of the present disclosure may be coupled to a side surface of a store fixture to capture visual data of an article of merchandise on another store fixture left, right, or above with respect to the store fixture such that inventory and tidiness information regarding the articles of merchandise on the other store fixture may be captured. In some implementations of the present disclosure, the merchandise monitoring camera may capture still image data periodically (e.g., every 5 to 10 seconds) in a predefined mode, and capture still image data at a higher frequency in peak seasons (e.g., during holidays, promotional period, high volume customer activities period, etc.), but are not limited to the examples provided herein.

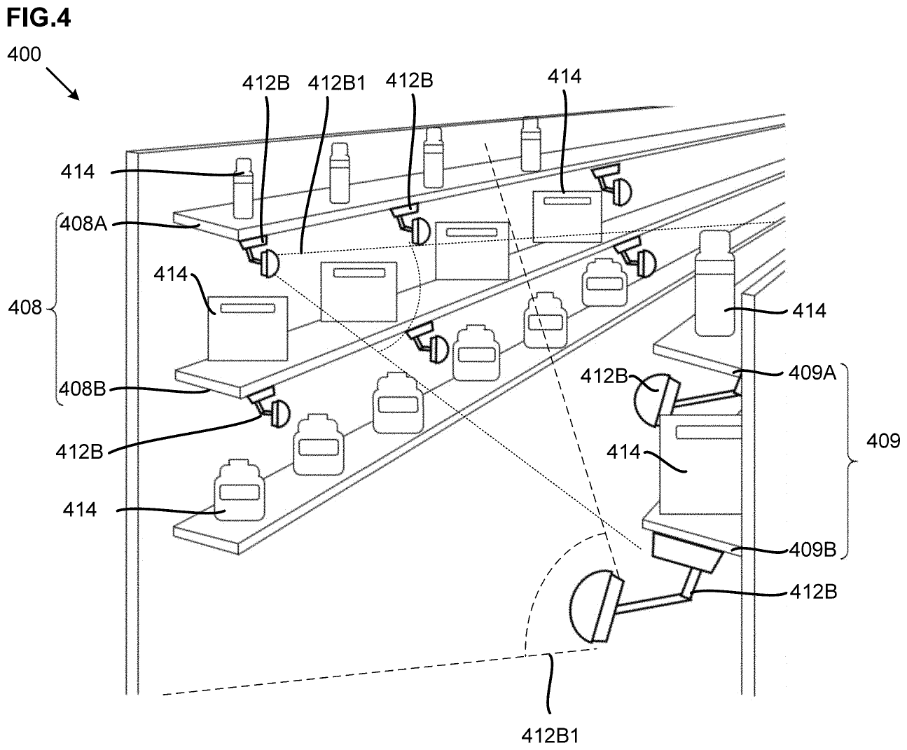

FIG. 4 is a schematic diagram of yet another example retail intelligent monitoring system in accordance with an example implementation of the present disclosure. In one or more implementations, the example system 400 may include a plurality of merchandise scanning cameras coupled to a plurality of third store fixtures and may be positioned toward a plurality of second store fixtures to capture visual data of articles of merchandise on the plurality of second store fixtures. In one or more implementations of the present disclosure, the plurality of merchandise scanning cameras 412B may be coupled to a plurality of shelves 408A, 408B on a first rack 408 and may be positioned toward another plurality of shelves 409A, 409B on a second rack 409 to capture visual data of the articles of merchandise 414 on the other plurality of shelves 409A, 409B on the second rack 409 such that inventory and tidiness information regarding the articles of merchandise 414 on the other plurality of shelves 409A, 409B of the second rack 409 may be captured. In a similar manner, a plurality of merchandise scanning cameras 412B may be coupled to the other plurality of shelves 409A, 409B on the second rack 409 and may be positioned toward the plurality of shelves 408A, 408B on the first rack 408 to capture visual data of the articles of merchandise 414 on the plurality of shelves 408A, 408B of the first rack 408 such that inventory and tidiness information regarding the articles of merchandise 414 on the plurality of shelves 408A, 408B of the first rack 408 may be captured.

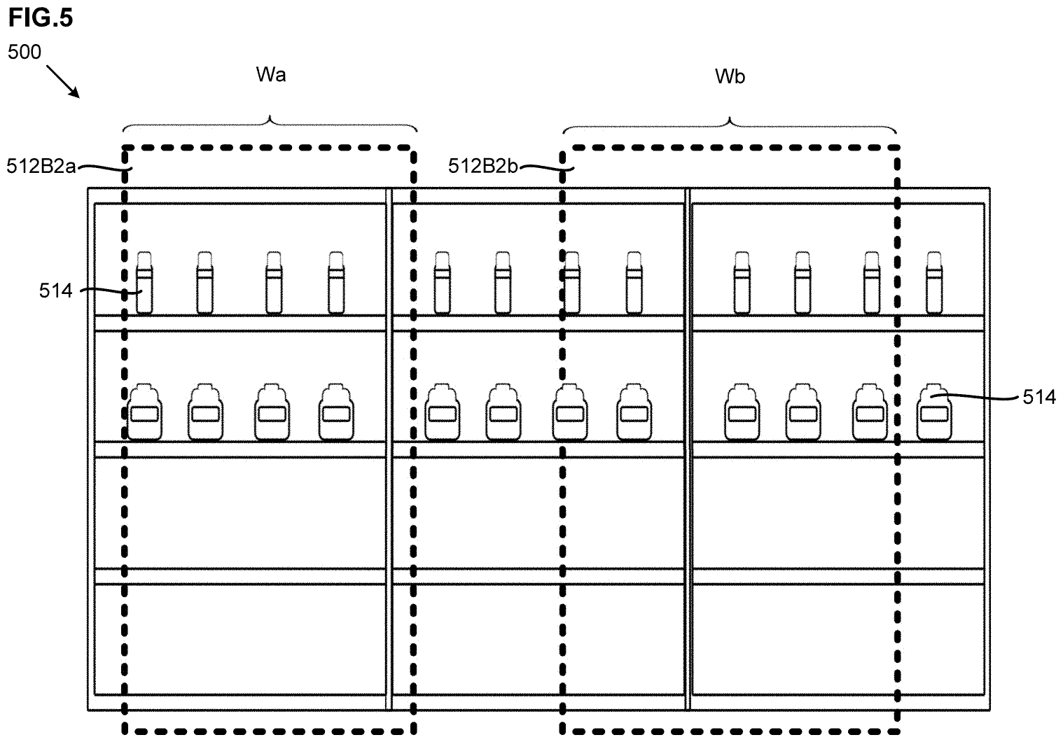

FIG. 5 is a schematic diagram illustrating example shutter frames of a camera of the retail intelligent monitoring system in accordance with an example implementation of the present disclosure. The example shutter frames 500 of a merchandise scanning camera (not explicitly shown) in accordance with an example implementation of the present disclosure is describe in FIG. 5. The merchandise scanning camera is substantially similar to the merchandise scanning cameras 212B in the example system 200 of FIG. 2, and the merchandise scanning cameras 412B in the example system 400 of FIG. 4 in the present disclosure, thus details regarding the merchandise scanning camera is omitted for brevity.

In one or more implementations, the merchandise scanning camera may capture second visual data (e.g., still images or videos, etc.) of the merchandise 514 on a store fixture in a standard shutter frame. In one or more implementations, the merchandise scanning camera may capture second visual data of the merchandise 514 on a store fixture in an adjustable shutter frame, which may include an adjustable width W to cover the dimensions of a store fixture, for example, a 5 to 6 feet wide by 8 feet high shelf. The adjustable shutter frame may be a shutter frame 512B2a having a basic width Wa or another shutter frame 512B2b having an extended width Wb. The basic width Wa may be about 5-6 feet and the extended with Wb may be about 8-10 feet, but are not limited to the example widths provided herein. The merchandise scanning camera of the present disclosure may capture visual data of the merchandise 514 at a high efficiency (e.g., resolution, etc.) when the width is set to basic width Wa while providing a wider coverage of visual date of the merchandise 514 when the width is set to extended width Wb. The adjustable shutter frame may also include a shutter frame with adjustable height similar to the adjustable width in one or more implementations.

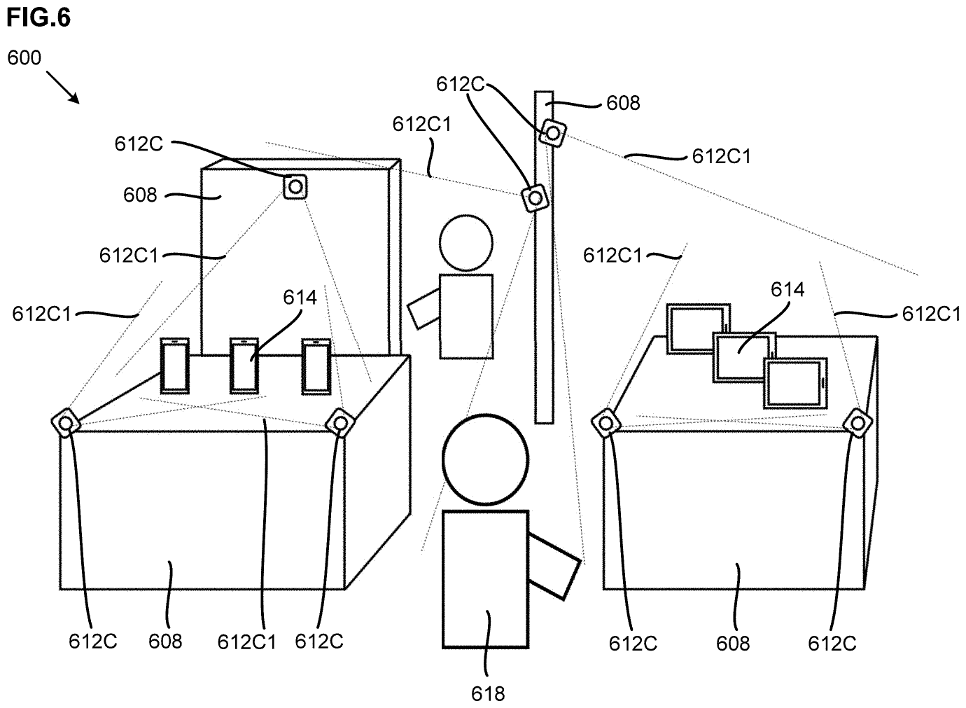

FIG. 6 is a schematic diagram of a plurality of cameras of an example retail intelligent monitoring system in a retail environment (e.g., store, warehouse, etc.) in accordance with an implementation of the present disclosure. The example of the retail intelligent monitoring system 600 may include a plurality of activity tracking cameras coupled to at least one store fixture (e.g., display table, etc.) to capture third visual data regarding shopper/customer activities within a predefined field of view of the activity tracking camera. The activity tracking camera is configured to automatically blur the customers'/shoppers' identities (e.g., faces, etc.) and capture the third visual data of the shopper/customer activities in the retail environment. In one or more implementations, the example retail intelligent monitoring system 600 may include a plurality of activity tracking cameras 612C coupled to at least one store fixture (e.g., a display table) 608 to capture the third visual data regarding activities of the customers/shoppers 618 within a predefined field of view 612C1 of the activity tracking camera 612C in the retail environment. The activity tracking camera 612C are configured to automatically blur the customers'/shoppers' identities (e.g., faces, etc.) and capture the third visual data of the shopper/customer activities without compromising the privacies of the customers/shoppers 618. In some implementations, the activity tracking cameras 612C may be configured to capture blurred visual data via a blurry lens capturing visual data or a software blurring the captured visual data to protect customers'/shoppers' privacies, such as identities. The examples of capturing blurry visual data of shopper/customer activities are not limited to the examples provided herein. In one or more implementations, the example retail intelligent monitoring system 600 may also include, but not shown, a terminal device, a network device, a routing device, and a data or power connector as shown in the retail intelligent monitoring system 100 in FIG. 1, the at least one merchandise monitoring camera, the at least one merchandise scanning camera, and the at least one activity tracking camera in the example systems 200, 300, and 400 in FIGS. 2, 3, and 4, respectively. In one or more implementations, the example retail intelligent monitoring system 600 may also include a merchandise scanning camera having example shutter frames 500 in FIG. 5.

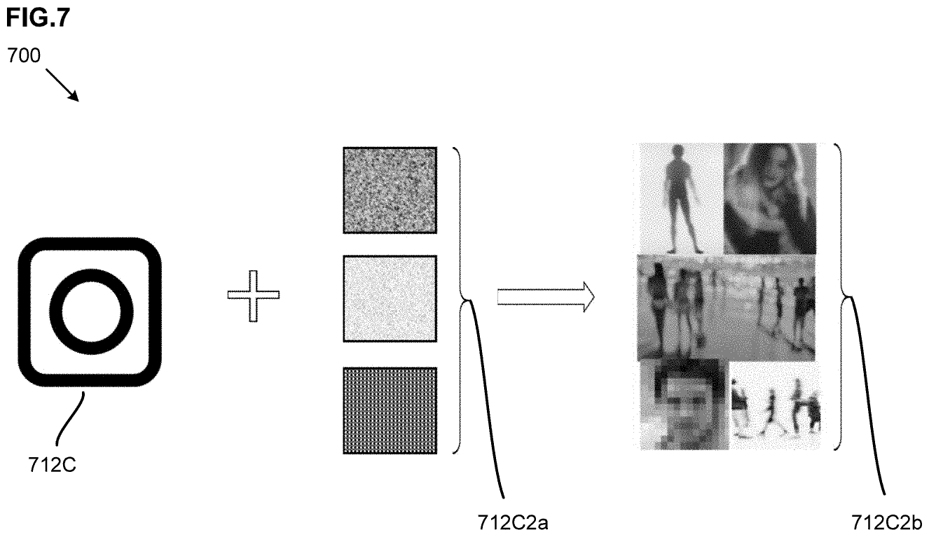

FIG. 7 is a schematic diagram illustrating example visual data processing with example filters applicable to a camera in accordance with an example implementation of the present disclosure. The example data processing 700 may include an activity tracking camera automatically blurring customers'/shoppers' identities (e.g., faces, etc.) and capturing the third visual data (e.g., images, videos, etc.) and output the third visual data of the customer/shopper activities. The example data processing 700 may include an activity tracking camera 712C with a plurality of filters 712C2a automatically blurring the customers'/shoppers' identities (e.g., faces, etc.) in the third visual data (e.g., images, videos, etc.). The example data processing 700 may output the third visual data 712C2b of the customer/shopper activities without compromising the customers'/shoppers' privacies. In some implementations, the activity tracking camera 712C may be configured to capture blurred visual data via a blurry lens capturing visual data or a software blurring the captured visual data to protect customers'/shoppers' privacies, such as identities. The examples of capturing blurry visual data of shopper/customer activities are not limited to the examples provided herein. In one or more implementations, the example visual data processing with example filters 712C2a that are applicable to the activity tracking camera 712C may also be the activity tracking camera 212C in the example system 200 of FIG. 2 and the activity tracking camera 612C in the example system 600 of FIG. 6.

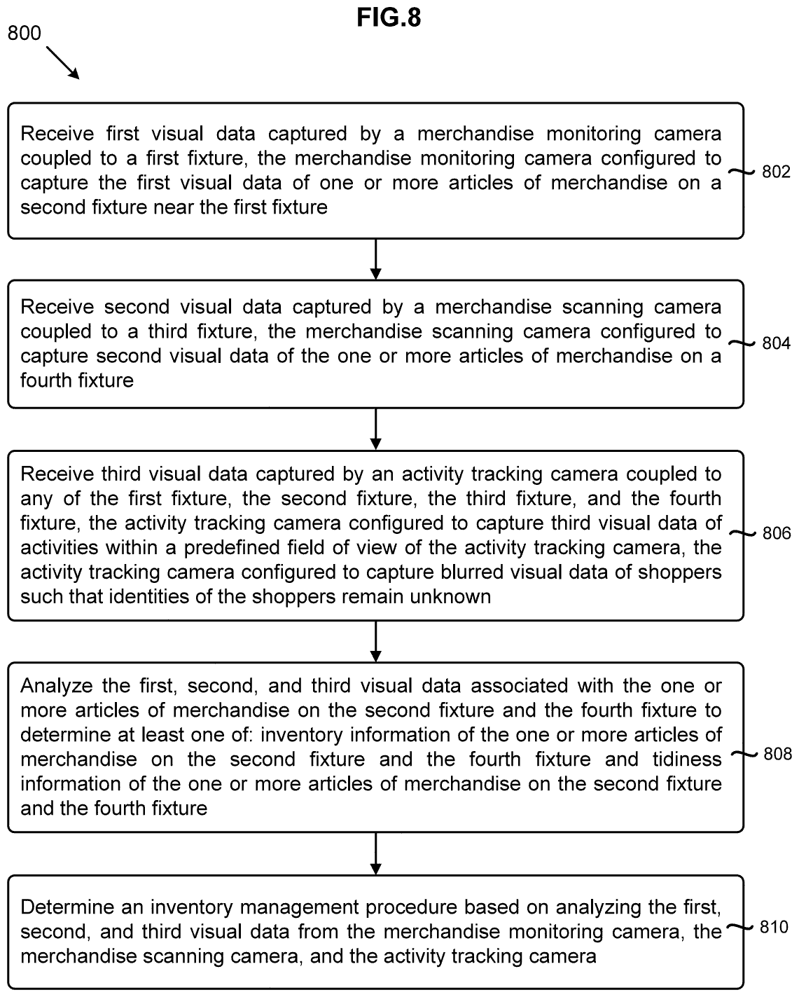

FIG. 8 is a flowchart diagram illustrating an example method performed by a retail intelligent monitoring system in accordance with example implementations of the present disclosure. The example implementation 800 of the method of the retail intelligent monitoring system in FIG. 8 may include a merchandise monitoring camera, a merchandise scanning camera, an activity tracking camera, and a network device as described in the example system 100 in FIG. 1, the example system 200 in FIG. 2, the example system 300 in FIG. 3, the example system 400 in FIG. 4, the example system 600 in FIG. 6, the example processing 700 in FIG. 7, and the example implementation in FIG. 5, thus details of the retail intelligent monitoring system of the present disclosure are omitted for brevity.

Referring to FIG. 8, in action 802, the retail intelligent monitoring system may receive first visual data captured by the merchandise monitoring camera that is coupled to a first store fixture, and the merchandise monitoring camera may be configured to capture the first visual data of one or more articles of merchandise on a second store fixture near the first store fixture.

In action 804, the retail intelligent monitoring system may further receive second visual data captured by the merchandise scanning camera that is coupled to a third store fixture, and the merchandise scanning camera may be configured to capture second visual data of the one or more articles of merchandise on a fourth store fixture.

In action 806, the retail intelligent monitoring system may further receive third visual data captured by the activity tracking camera that is coupled to any of the first store fixture, the second store fixture, the third store fixture, and the fourth store fixture. The activity tracking camera may be configured to capture third visual data of activities within a predefined field of view of the activity tracking camera. The activity tracking camera may be configured to capture blurred visual data of shoppers such that identifies the shoppers remain unknown. In some implementations, the activity tracking camera may be configured to capture blurred visual data via a blurry lens capturing visual data or a software blurring the captured visual data to protect customers'/shoppers' privacies, such as identities. The examples of capturing blurry visual data of shopper/customer activities are not limited to the examples provided herein.

In action 808, the retail intelligent monitoring system may further analyze the first, second, and third visual data associated with the one or more articles of merchandise on the second store fixture and the fourth store fixture to determine at least one of inventory information of the one or more articles of merchandise on the second store fixture and the fourth store fixture and tidiness information of the one or more articles of merchandise on the second store fixture and the fourth store fixture.

In action 810, the retail intelligent monitoring system may further determine an inventory management procedure based on analyzing the first, second, and third visual data from the merchandise monitoring camera, the merchandise scanning camera, and the activity tracking camera.

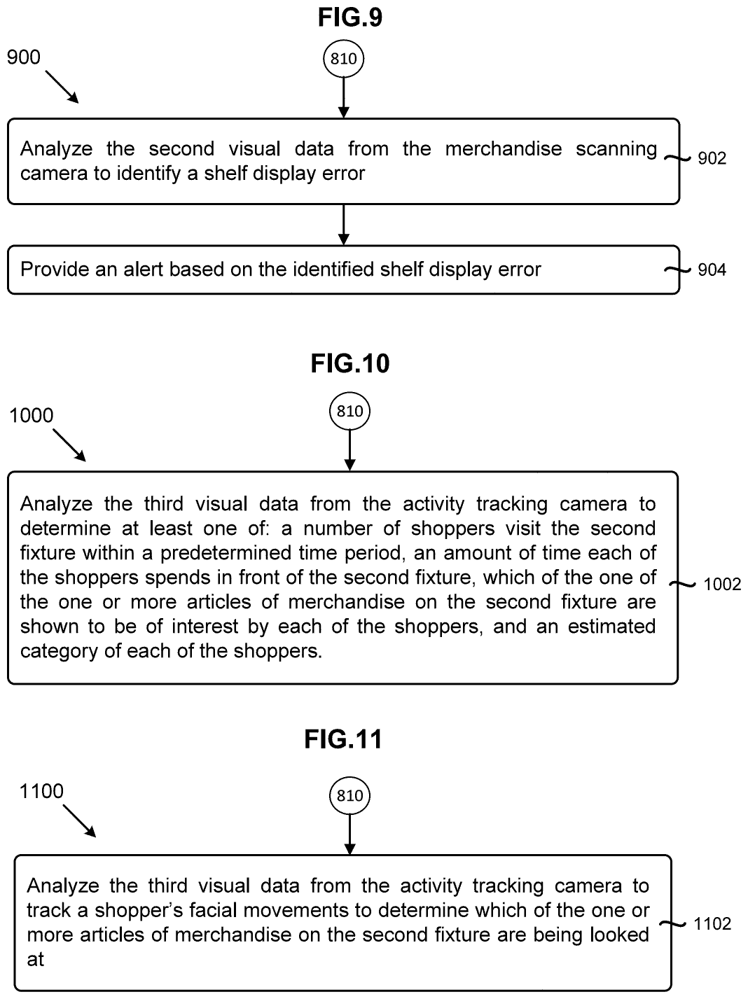

FIG. 9 is a flowchart diagram further illustrating an example implementation of the method of the retail intelligent monitoring system in FIG. 8. The example implementation 900 of the method of the retail intelligent monitoring system in FIG. 9 may include a merchandise monitoring camera, a merchandise scanning camera, an activity tracking camera, and a network device as described in the example system 100 in FIG. 1, the example system 200 in FIG. 2, the example system 300 in FIG. 3, the example system 400 in FIG. 4, the example system 600 in FIG. 6, the example processing 700 in FIG. 7, and the example implementation in FIG. 5. Thus, details regarding the retail intelligent monitoring system are omitted for brevity.

Referring to FIG. 9, in action 902, after the retail intelligent monitoring system further determine an inventory management procedure based on analyzing the first, second, and third visual data from the merchandise monitoring camera, the merchandise scanning camera, and the activity tracking camera in action 810 of FIG. 8, the retail intelligent monitoring system may further analyze the second visual data from the merchandise scanning camera to identify a shelf display error.

In action 904, the retail intelligent monitoring system may further provide an alert based on the identified shelf display error.

FIG. 10 is a flowchart diagram further illustrating another example implementation of the method of the retail intelligent monitoring system in FIG. 8. The example implementation 1000 of the method of the retail intelligent monitoring system in FIG. 10 may include a merchandise monitoring camera, a merchandise scanning camera, an activity tracking camera, and a network device as described in the example system 100 in FIG. 1, the example system 200 in FIG. 2, the example system 300 in FIG. 3, the example system 400 in FIG. 4, the example system 600 in FIG. 6, the example processing 700 in FIG. 7, and the example implementation in FIG. 5. Thus, details regarding the retail intelligent monitoring system are omitted for brevity.

Referring to FIG. 10, in action 1002, after the retail intelligent monitoring system further determine an inventory management procedure based on analyzing the first, second, and third visual data from the merchandise monitoring camera, the merchandise scanning camera, and the activity tracking camera in action 810 of FIG. 8, the retail intelligent monitoring system may further analyze the third visual data from the activity tracking camera to determine at least one of a number of shoppers visit the second store fixture within a predetermined time period, an amount of time each shopper spends in front of the second store fixture, which of the one of the one or more articles of merchandise on the second store fixture are shown to be of interest by each of the shoppers, and an estimated group or category of each of the shoppers.

FIG. 11 is a flowchart diagram further illustrating another example implementation of the method of the retail intelligent monitoring system in FIG. 8. The example implementation 1100 of the method of the retail intelligent monitoring system in FIG. 11 may include a merchandise monitoring camera, a merchandise scanning camera, an activity tracking camera, and a network device as described in the example system 100 in FIG. 1, the example system 200 in FIG. 2, the example system 300 in FIG. 3, the example system 400 in FIG. 4, the example system 600 in FIG. 6, the example processing 700 in FIG. 7, and the example implementation in FIG. 5. Thus, details regarding the retail intelligent monitoring system are omitted for brevity.

Referring to FIG. 11, in action 1102, after the retail intelligent monitoring system further determine an inventory management procedure based on analyzing the first, second, and third visual data from the merchandise monitoring camera, the merchandise scanning camera, and the activity tracking camera in action 810 of FIG. 8, the retail intelligent monitoring system may further analyze the third visual data from the activity tracking camera to track a shopper's facial (e.g., eye) movements to determine which of the one or more articles of merchandise on the second store fixture are being looked at.

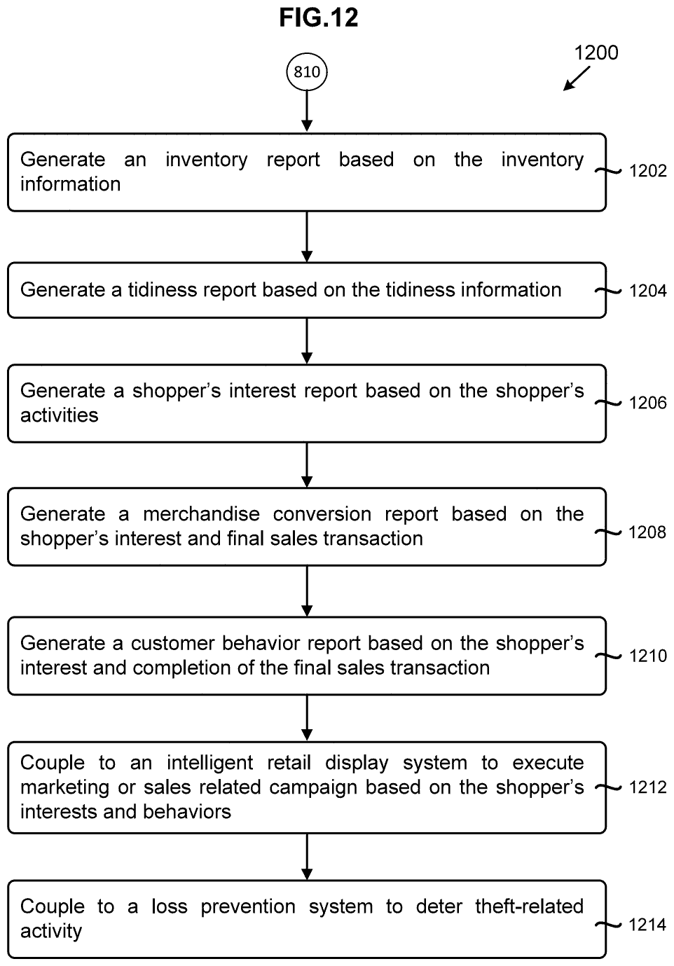

FIG. 12 is a flowchart diagram further illustrating another example implementation of the method of the retail intelligent monitoring system in FIG. 8. The example implementation 1200 of the method of the retail intelligent monitoring system in FIG. 12 may include a merchandise monitoring camera, a merchandise scanning camera, an activity tracking camera, and a network device as described in the example system 100 in FIG. 1, the example system 200 in FIG. 2, the example structure 300 in FIG. 3, the example system 400 in FIG. 4, the example system 600 in FIG. 6, the example processing 700 in FIG. 7, and the example implementation in FIG. 5. Thus, details regarding the retail intelligent monitoring system are omitted for brevity.

Referring to FIG. 12, in action 1202, after the retail intelligent monitoring system further determine an inventory management procedure based on analyzing the first, second, and third visual data from the merchandise monitoring camera, the merchandise scanning camera, and the activity tracking camera in action 810 of FIG. 8, the retail intelligent monitoring system may further generate an inventory report based on the inventory information.

In action 1204, the retail intelligent monitoring system may further generate a tidiness report based on the tidiness information.

In action 1206, the retail intelligent monitoring system may further generate a shopper's interest report based on the shopper's activities.

In action 1208, the retail intelligent monitoring system may further generate a merchandise conversion report based on the shopper's interest and final sales transaction. The merchandise conversion report may be similar to an online shopping conversion rate. For example, a shopped-to-transaction ratio or rate which indicates a ratio or rate of shopped frequency to transaction completed frequency (e.g., 50 shopped items to 0 transaction without any transaction completed).

In action 1210, the retail intelligent monitoring system may further generate a customer behavioral report based on the shopper's interest and completion of the final sales transaction.

In action 1212, the retail intelligent monitoring system may further couple to a retail intelligent display system to execute marketing or sales related campaign based on the shopper's interests and behaviors. In some implementations, the retail intelligent display system may execute marketing or sales related campaign based on the shoppers' interests and behaviors by displaying marketing or sales (e.g., advertising) content. The retail intelligent display system may display marketing or sales content when the retail intelligent monitoring system determines that at least one shopper visited a fixture having a merchandise (e.g., the retail intelligent monitoring system may analyze proximity of the shopper and the fixture having the merchandise based on visual data captured by an activity tracking camera) and the shopper looked at a certain section of the fixture having the merchandise (e.g., the retail intelligent monitoring system may analyze the shopper's facial (or eye) movements based on the visual data captured by the activity tracking camera). In some implementations, the retail intelligent display system may display inventory information of a merchandise (e.g., fully stocked, low in stock, or out of stock in a store), for example, on a display and may display further inventory information (e.g., stock quantity in other stores or a store website) such that the shopper may determine whether to order an merchandise (e.g., order at a store or order online via a mobile device/terminal).

In action 1214, the retail intelligent monitoring system may further couple to a loss prevention system to deter theft-related activity.

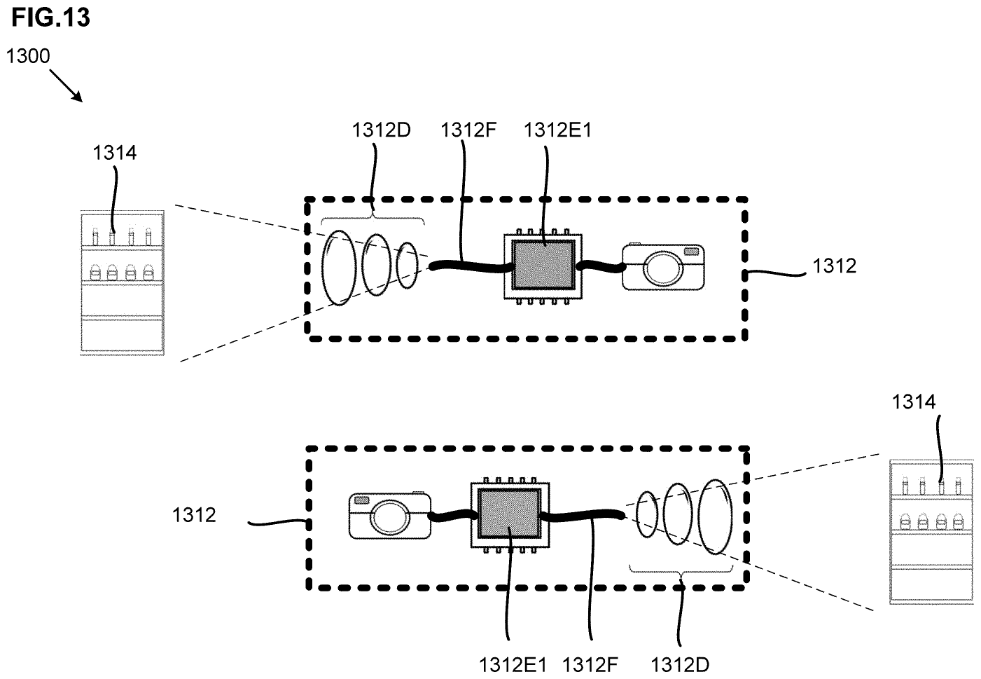

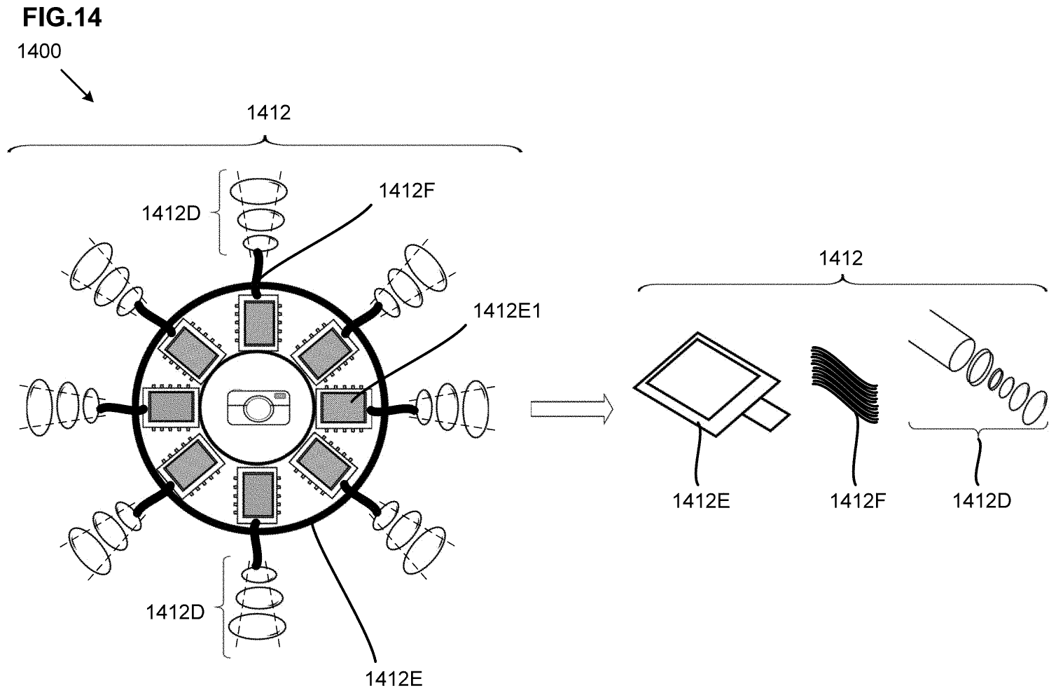

FIG. 13 is a schematic diagram illustrating a plurality of camera modules of an example retail intelligent monitoring system in a retail environment in accordance with an implementation of the present disclosure.

In one or more implementations, the example retail intelligent monitoring system 1300 may include a plurality of camera modules 1312 each having a lens module 1312D, an image sensor 1312E1, and a fibre-optic cable 1312F connecting the lens module 1312D with the image sensor 1312E1 for data communication such that visual data 1314 of at least one article of merchandise on at least one store fixture may be captured. In some implementations, the lens module 1312D may include a plurality of lenses. In some implementations, each of the plurality of camera modules 1312 may include one lens module 1312D, one image sensor 1312E1, and at least one fibre-optic cable 1312F that may replace the combination of the merchandise monitoring camera, the merchandise scanning camera, and the activity tracking camera of the present disclosure and be coupled to any store fixture such that the example retail intelligent monitoring system 1300 may capture visual data of at least one article of merchandise on another store fixture, may automatically blur the captured visual data of shoppers/customers and output anonymous data, analyze the captured visual data, and determine an inventory management procedure based on the analyzed visual data. The camera modules 1312 of the example retail intelligent monitoring system 1300 are not limited to the examples provided herein. In some implementations, the one lens module 1312D may be a blurry lens configured to capture blurred visual data or the camera modules 1312 may blur the captured visual data (e.g., via software processing) to protect customers'/shoppers' privacies, such as identities. The examples of capturing blurry visual data of shopper/customer activities are not limited to the examples provided herein.

In addition to the camera modules 1312, the example retail intelligent monitoring system in FIG. 1300 may include also include a network device, a routing device, at least one store fixture, and a data/power connector similar to that as described in the example system 100 in FIG. 1, the example system 200 in FIG. 2, the example system 300 in FIG. 3, the example system 400 in FIG. 4, the example system 600 in FIG. 6, the example processing 700 in FIG. 7, and the example implementation in FIG. 5, thus details of the retail intelligent monitoring system of the present disclosure are omitted for brevity.

FIG. 14 is a schematic diagram illustrating a camera module of an example retail intelligent monitoring system in accordance with an implementation of the present disclosure.

In one or more implementations, the example retail intelligent monitoring system 1400 may include a single camera module 1412 similar to the camera module 1312 in the example retail intelligent monitoring system 1300 with the difference in that the single camera module 1412 may include a plurality of lens modules 1412D each having a plurality of lenses, an image sensor 1412E having a plurality of image sensors 1412E1, and at least one fiber-optic cable 1412F connecting the plurality of lens modules 1412D with the plurality of image sensors 1412E1, respectively. The single camera module 1412 of the example retail intelligent monitoring system 1400 may replace the combination of the merchandise monitoring camera, the merchandise scanning camera, and the activity tracking camera of the present disclosure and be coupled to any store fixture such that the example retail intelligent monitoring system 1400 may capture visual data of at least one article of merchandise on another store fixture may be captured, may automatically blur captured visual data of shoppers/customers and output anonymous data, analyze the captured visual data, and determine an inventory management procedure based on the analyzed visual data. For example, the single camera module 1412 may switch between different sets of the lens module 1412D and the image sensor 1412E1 via the corresponding fiber-optic cable 1412F to capture visual data of at least one article of merchandise on one or more store fixtures, thus reducing the overall number of camera modules of retail intelligent monitoring system 1400, and providing significant overall cost savings and an alternative to the camera modules 1312 in the example retail intelligent monitoring system 1300. The camera module 1412 of the present implementation are not limited to the examples provided herein. In some implementations, the one lens module 1412D may be a blurry lens configured to capture blurred visual data or the camera modules 1412 may blur the captured visual data (e.g., through software processing) to protect customers'/shoppers' privacies, such as identities. The examples of capturing blurry visual data of shopper/customer activities are not limited to the examples provided herein.

In addition to the camera module 1412, the example retail intelligent monitoring system in FIG. 1400 may include also include a network device, a routing device, at least one store fixture, and a data/power connector similar to that as described in the example system 100 in FIG. 1, the example system 200 in FIG. 2, the example system 300 in FIG. 3, the example system 400 in FIG. 4, the example system 600 in FIG. 6, the example processing 700 in FIG. 7, and the example implementation in FIG. 5, thus details of the retail intelligent monitoring system of the present disclosure are omitted for brevity.

In one or more implementations, the retail intelligent monitoring system of the present disclosure may include a merchandise display camera, a merchandise scanning camera, and a activity tracking camera as discussed above or may include a camera module with an image sensor and multiple lens as discussed above. The merchandise display camera, the merchandise scanning camera, the activity tracking camera, and the cameras module with multiple lens may be readily attachable to and removable from store fixtures. In other implementations, the merchandise display camera, the merchandise scanning camera, the activity tracking camera, and the cameras module with multiple lens may be vandal proof, scratch resistant, and can only be removed by special designed tool. In other implementations, the merchandise display camera, the merchandise scanning camera, the activity tracking camera, and the cameras module with multiple lens may include cameras that are readily attachable to and removable from store fixtures as well as other cameras that are vandal proof, scratch resistant, and can only be removed by special designed tool. In other implementations, the merchandise display camera, the merchandise scanning camera, the activity tracking camera, and the cameras module with multiple lens may include cameras that are readily attachable to and removable from store fixtures as well as other cameras that are vandal proof, scratch resistant, and can only be removed by special designed tool. In other implementations, the merchandise display camera, the merchandise scanning camera, the activity tracking camera, and the cameras module with multiple lens may include cameras connected to the store fixtures with special connector where the store fixtures will have the base for connector.

From the present disclosure, it can be seen that various techniques may be used for implementing the concepts described in the present disclosure without departing from the scope of those concepts. While the concepts have been described with specific reference to certain implementations, a person of ordinary skill in the art may recognize that changes may be made in form and detail without departing from the scope of those concepts.

As such, the described implementations are to be considered in all respects as illustrative and not restrictive. It should also be understood that the present disclosure is not limited to the particular implementations described but rather many rearrangements, modifications, and substitutions are possible without departing from the scope of the present disclosure.

What is claimed is:

1. A retail intelligent monitoring system, comprising:
a merchandise monitoring camera coupled to a surface of a first fixture, the merchandise monitoring camera configured to capture first visual data of one or more articles of merchandise on a second fixture near the first fixture;
a merchandise scanning camera coupled to a third fixture, the merchandise scanning camera positioned toward the fourth fixture and configured to capture second visual data of the one or more articles of merchandise on the fourth fixture;
an activity tracking camera coupled to any one of the first fixture, the second fixture, the third fixture, and the fourth fixture and configured to capture third visual data of activities within a predefined field of view of the activity tracking camera, the activity tracking camera configured to capture blurred visual data of shoppers such that identities of the shoppers remain unknown; and
a network device comprising:
a communication module communicatively coupled to the merchandise monitoring camera, the merchandise scanning camera, and the activity tracking camera;
a processor communicatively coupled to the communication module; and
a non-transitory machine-readable memory storing instructions that, when executed by the processor, cause the retail intelligent monitoring system to:
receive the first, second, and third visual data;
analyze the first, second, and third visual data associated with the one or more articles of merchandise on the second fixture and the fourth fixture to determine at least one of:
inventory information of the one or more articles of merchandise on the second fixture and the fourth fixture; and
tidiness information of the one or more articles of merchandise on the second fixture and the fourth fixture; and
determine an inventory management procedure based on analyzing the first, second, and third visual data from the merchandise monitoring camera, the merchandise scanning camera, and the activity tracking camera.

2. The retail intelligent monitoring system of claim 1, wherein the merchandise monitoring camera is configured to capture images of the one or more articles of merchandise on the second fixture at pre-determined time intervals.

3. The retail intelligent monitoring system of claim 1, wherein the merchandise scanning camera is configured to capture images of the one or more articles of merchandise on the second fixture at pre-determined time intervals.

4. The retail intelligent monitoring system of claim 1, wherein the merchandise scanning camera includes an adjustable shutter frame.

5. The retail intelligent monitoring system of claim 1, wherein the merchandise scanning camera is coupled to the third fixture facing the fourth fixture on an opposite side of an aisle.

6. The retail intelligent monitoring system of claim 1, wherein the non-transitory machine-readable memory stores additional instructions that, when executed by the processor, cause the intelligent monitoring system to:
analyze the second visual data from the merchandise scanning camera to identify a shelf display error; and
provide an alert based on the identified shelf display error.

7. The retail intelligent monitoring system of claim 1, wherein the non-transitory machine-readable memory stores additional instructions that, when executed by the processor, cause the intelligent monitoring system to:
analyze the third visual data from the activity tracking camera to determine at least one of:
a number of shoppers visit the second fixture within a predetermined time period;
an amount of time each of the shoppers spends in front of the second fixture;
which of the one of the one or more articles of merchandise on the second fixture are shown to be of interest by each of the shoppers; and
an estimated group or category of each of the shoppers.

8. The retail intelligent monitoring system of claim 1, wherein the non-transitory machine-readable memory stores additional instructions that, when executed by the processor, cause the intelligent monitoring system to:
analyze the third visual data from the activity tracking camera to track a shopper's facial movements to determine which of the one or more articles of merchandise on the second fixture are being looked at.

9. The retail intelligent monitoring system of claim 1, wherein the inventory management procedure includes at least one of:
generating an inventory report based on the inventory information;
generating a tidiness report based on the tidiness information;
generating a shopper's interest report based on the shopper's activities;
generating a merchandise conversion report based on the shopper's interest and final sales transaction;
generating a customer behavioral report based on the shopper's interest and completion of the final sales transaction;
coupling to a retail intelligent display system to execute marketing or sales related campaign based on the shopper's interests and behaviors; and
coupling to a loss prevention system to deter theft-related activity.

10. The retail intelligent monitoring system of claim 1, wherein the inventory management procedure includes at least one of:
generate an inventory alert based on the inventory information; and
generate a tidiness alert based on the tidiness information.

11. The retail intelligent monitoring system of claim 1, wherein the network device is coupled to a backend device.

12. A method for a retail intelligent monitoring system including a merchandise monitoring camera, a merchandise scanning camera, an activity tracking camera, and a network device, the method comprising:
receiving first visual data captured by the merchandise monitoring camera coupled to a first fixture, the merchandise monitoring camera configured to capture the first visual data of one or more articles of merchandise on a second fixture near the first fixture;
receiving second visual data captured by the merchandise scanning camera coupled to a third fixture, the merchandise scanning camera configured to capture second visual data of the one or more articles of merchandise on a fourth fixture;
receiving third visual data captured by the activity tracking camera coupled to any of the first fixture, the second fixture, the third fixture, and the fourth fixture, the activity tracking camera configured to capture third visual data of activities within a predefined field of view of the activity tracking camera, the activity tracking camera configured to capture blurred visual data of shoppers such that identities of the shoppers remain unknown;
analyzing the first, second, and third visual data associated with the one or more articles of merchandise on the second fixture and the fourth fixture to determine at least one of:
inventory information of the one or more articles of merchandise on the second fixture and the fourth fixture; and
tidiness information of the one or more articles of merchandise on the second fixture and the fourth fixture; and
determining an inventory management procedure based on analyzing the first, second, and third visual data from the merchandise monitoring camera, the merchandise scanning camera, and the activity tracking camera.

13. The method of claim 12, wherein the merchandise monitoring camera is configured to capture images of the one or more articles of merchandise on the second fixture at pre-determined time intervals.

14. The method of claim 12, wherein the merchandise scanning camera is configured to capture images of the one or more articles of merchandise on the fourth fixture at pre-determined time intervals.

15. The method of claim 12, wherein the merchandise scanning camera includes an adjustable shutter frame.

16. The method of claim 12, wherein the merchandise scanning camera is coupled to the third fixture facing the fourth fixture on an opposite side of an aisle.

17. The method of claim 12, further comprising:
analyzing the second visual data from the merchandise scanning camera to identify a shelf display error; and
providing an alert based on the identified shelf display error.

18. The method of claim 12, further comprising:
analyzing the third visual data from the activity tracking camera to determine at least one of:
a number of shoppers visit the second fixture within a predetermined time period;
an amount of time each of the shoppers spends in front of the second fixture;
which of the one of the one or more articles of merchandise on the second fixture are shown to be of interest by each of the shoppers; and
an estimated group or category of each of the shoppers.

19. The method of claim 12, further comprising:
analyzing the third visual data from the activity tracking camera to track a shopper's facial movements to determine which of the one or more articles of merchandise on the second fixture are being looked at.

20. The method of claim 12, further comprising:
generating an inventory report based on the inventory information;
generating a tidiness report based on the tidiness information;
generating a shopper's interest report based on the shopper's activities;
generating a merchandise conversion report based on the shopper's interest and final sales transaction;
generating a customer behavioral report based on the shopper's interest and completion of the final sales transaction;
coupling to a retail intelligent display system to execute marketing or sales related campaign based on the shopper's interests and behaviors; and
coupling to a loss prevention system to deter theft-related activity.
